(19) United States
(12) Patent Application Publication
(10) Pub. No.: US 2012/0033065 A1
(43) Pub. Date: Feb. 9, 2012

(54) SENSOR ARRANGEMENT FOR A CONSTRUCTION MACHINE

(75) Inventors: Achim Eul, Mannheim (DE); Horst Ramb, Worms (DE)

(73) Assignee: JOSEPH VOGELE AG, Ludwigshafen/Rhein (DE)

(21) Appl. No.: 13/193,829

(22) Filed: Jul. 29, 2011

(30) Foreign Application Priority Data
Aug. 6, 2010 (DE) 10 008 250.2

(51) Int. Cl. H04N 7/18; G01N 29/00; G01N 1/00

(52) U.S. Cl. 348/86; 73/863; 73/632; 348/E07.085

(57) ABSTRACT

The invention relates to a sensor arrangement for a construction machine with a sensor which is set up for gathering measurement data from a sampling region or from a sampling point. The invention is characterised in that an illumination device for illuminating the sampling region or the sampling point is integrated into the sensor arrangement.

The invention relates to a sensor arrangement for a construction machine which is set up to gather measurement data from a sampling region or from a sampling point.

Sensor arrangements of this nature for construction machines, such as for example pavement laying machines, are known from practice. The measurement data gathered therefrom are used to inspect the working result of the construction machine, in particular the quality of this working result, and to set the operating parameters of the construction machine according to the measurement data in order to achieve the best possible working result.

A disadvantage of the conventional sensor arrangements is that they are subjected to very high levels of stress and soiling due to the working environment of the construction machine. This can result in the measurement data supplied by a sensor in the sensor arrangement being unreliable. Due to the unreliable, erroneous measurement data, the operation of the construction machine can be impaired and the working result achieved may be further degraded if the operating parameters of the construction machine are incorrectly set on account of the unreliable measurement data.

The object of the present invention is to make a sensor arrangement available, which facilitates a more reliable operation of the construction machine with the most constructively simple means.

The object is solved by a sensor arrangement that is set up to gather measurement data from a sampling region or a sampling point, and having an illumination device for illuminating the sampling region or the sampling point integrated into the sensor arrangement. Advantageous further developments of the invention are given in the dependent claims.

The sensor arrangement according to the invention is characterised in that an illumination device for illuminating the sampling region or the sampling point of the sensor is integrated into the sensor arrangement. This offers a whole range of advantages. Due to the illumination of the sampling region or the sampling point from which the sensor gathers measurement data, the contrast is increased here such that the measurement data are more accurate. Even when the construction machine is operated at night or in a building structure or tunnel, i.e. in the dark, the illumination enables an operator of the construction machine to check the quality and the surface condition of the sampling region or the sampling point. In this way he can visually inspect the quality of the working result and whether the sampling region or sampling point (combined in the following as the sampling field) is sufficiently clean so that reliable measurement data can be expected from the sensor. It is also advantageous in that, due to the integration of the illumination device into the sensor arrangement, cabling to an external illumination device can be avoided, and that the quality of the illumination is independent of whether and optionally in which form external illumination elements are present on the construction site (for example, on masts). Furthermore, it is no longer necessary to align an existing working light on the construction machine to the sampling field in order to inspect the quality of this sampling field, so that the working light can be used for its designated purpose of illuminating the working area of the construction machine.

The sensor present in the sensor arrangement may be, for example, a mechanical sensor or a non-contacting sensor. It is also within the scope of the present invention to have a plurality of sensors present in the sensor arrangement and that these sensors evaluate a common sampling field or different sampling fields.

For example, the sensor may be an optical sensor, or a non-optical sensor, such as e.g. an inductive sensor, a capacitive sensor or an ultrasonic sensor. Even with non-optical sensors of this nature the illumination device provided according to the invention is advantageous in order to be able to visually inspect the surface quality and the level of soiling of the sampling field. However, it is conceivable that a light or shadow pattern in the sampling field achieved by means of the illumination device is detected by means of the sensor and is used to gather measurement data. For this purpose the illumination device might produce a structured light pattern, for example, a line or grid. Depending on the position and/or the deformation of this light pattern conclusions regarding the properties of the sampling field and thus regarding the quality of the working result of the construction machine might be obtained.

The illumination device could be formed for emitting visible and/or infrared light. Visible light has the advantage that it facilitates a visual check of the sampling field by the operator of the construction machine.

It is expedient if the illumination device has an optical system for defining and optionally for modifying the region illuminated by the illumination device. This illumination device may contain reflectors and/or optical lenses and in this way define where the illuminated region lies and which dimensions it has.

It is particularly favourable if the optical system is adjustable in order to modify the position and / or the size of the region illuminated by the illumination device. In this way the illuminated region can be adapted to the changing operating conditions, for example to a changing distance between the sensor and the sampling field.

In a further advantageous variant of the invention the brightness of the illumination device is variable to facilitate an optimum illumination of the working field with simultaneously the lowest possible energy consumption.

It is conceivable that the sensor does not gather measurement data continuously, but rather that it is set up for discontinuous gathering of measurement data, for example, according to fixed or variable measurement intervals. In this case it is advantageous if the illumination device is set up such that it only emits light while the sensor gathers measurement data, so that energy can be saved during the inactive state of the sensor.

In a further variant of the invention the sensor arrangement has a camera aligned on the sampling field. By means of this camera the operator can visually inspect the sampling field illuminated by the illumination device without having to move to the sampling field.

It can also be expedient if the illumination device can be activated independently of the sensor operation. In this case the illumination device can be switched on, for example, to visually check the sampling field without the sensor having to be switched on as well.

The invention also relates to a construction machine, for example a road finisher or a charging machine, with a sensor arrangement of the above described type.

In the following an advantageous embodiment of the invention is explained in more detail based on a drawing.

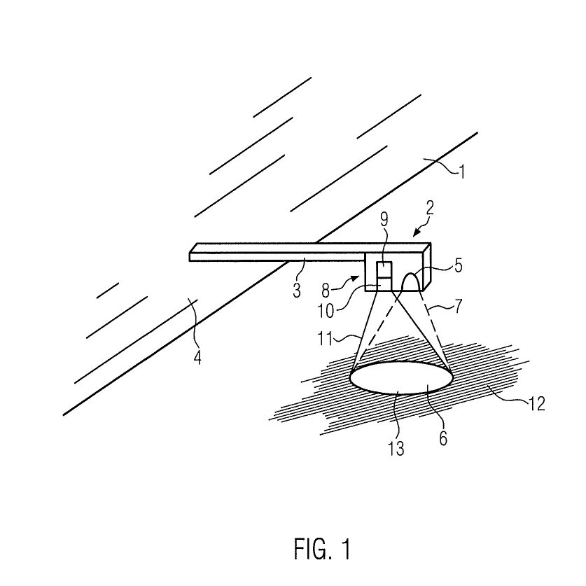

FIG. 1 shows a perspective view of an embodiment of a construction machine 1 with a sensor arrangement 2 according to the invention. The construction machine 1 may be a road finisher or a charging machine for a road finisher. However, it may also be another construction machine which can be employed in darkness or in dark spaces, for example in a tunnel, or in areas which are darkened inside, from which however measurement data is to be gathered.

In the illustrated embodiment the sensor arrangement 2 is mounted on a component 4 of the construction machine 1 by means of an extension arm 3, for example on an outer or inner wall 4 of the construction machine 1. Alternatively, it is also conceivable that the sensor arrangement 2 is integrated into the component 4 of the construction machine 1.

It is schematically indicated that the sensor arrangement 2 has a sensor 5 which is set up to gather measurement data from a sampling region 6. The sampling or acquisition angle of the sensor 5 is indicated by the broken lines 7.

The sensor 5 may be a mechanical sensor or a non-contacting sensor. For example, it is an ultrasonic material sensor on a screw conveyor of the construction machine 1, an ultrasonic level sensor or a mechanical long-range probe. The measurement data gathered by the sensor 5 are used to represent a state on or in the construction machine 1 or a working result achieved by means of the construction machine 1.

According to the invention an illumination device 8 is integrated into the sensor arrangement 2. The illumination device 8 comprises a light source 9 for producing, for example, visible light. The light source 9 may be an LED or an array of LEDs. Furthermore, the illumination device 8 has an optical system 10 arranged in front of the light source 9. This optical system 10 can comprise reflectors and/or lenses. It is used to form the light produced by the light source 9 into a conical beam 11.

Here, where the conical beam 11 from the illumination device 8 meets an otherwise dark working surface 12 an illuminated region 13 is created by the illumination. In the present embodiment the optical system of the illumination device 8 is set such that the illuminated region 13 exactly matches the sampling region 6 of the sensor 5. The light source 9 and the optical system 10 can be controlled preferably by means of a controller such that the brightness of the conical beam 11 and the divergence of this conical beam 11 can be varied so that the illumination can adapt, for example, to a varying distance between the sensor arrangement 2 and the working surface 12.

In the operation of the construction machine 1 the illumination device 8 can illuminate the region 13 on the working surface 12 when the sensor 5 is active and is acquiring measurement data or when the illumination device 8 has been activated independently of the operation of the sensor 5 by an operator of the construction machine 1.

Starting from the illustrated embodiment, the sensor arrangement 2 according to the invention can be modified in many ways. For example it would be possible to integrate a plurality of sensors 5 into the sensor device 2. Furthermore, a camera could be provided in the sensor arrangement 2, by means of which the region 13 illuminated by the illumination device 8 is acquired. The picture supplied by the camera could be displayed on a display device for the operator of the construction machine 1.

1. Sensor arrangement for a construction machine comprising a sensor set up to gather measurement data from a sampling region or a sampling point, and an illumination device integrated into the sensor arrangement for illuminating the sampling region or the sampling point.

2. Sensor arrangement according to claim 1, wherein the sensor is a mechanical sensor or a non-contacting sensor.

3. Sensor arrangement according to claim 1, wherein the sensor is an optical sensor, an inductive sensor, a capacitive sensor or an ultrasonic sensor.

4. Sensor arrangement according to claim 1, wherein the illumination device is adapted for emitting visible and/or infrared light.

5. Sensor arrangement according to claim 1, wherein the illumination device includes an optical system for defining the region illuminated by the illumination device.

6. Sensor arrangement according to claim 5, wherein the optical system can be set to vary the position and/or the size of the region illuminated by the illumination device.

7. Sensor arrangement according to claim 1 wherein the brightness of the illumination device is variable.

8. Sensor arrangement according to claim 5, wherein the sensor is arranged for the discontinuous gathering of measurement data and the illumination device is emits light only during the gathering of measurement data by the sensor.

9. Sensor arrangement according to claim 1, wherein the sensor arrangement has a camera aligned with the sampling region or the sampling point.

10. Sensor arrangement according to claim 1, wherein the illumination device can be activated independently of the operation of the sensor.

11. Construction machine comprising the sensor arrangement according to claim 1.

12. Construction machine according to claim 11, wherein the construction machine is a road finisher or a charging machine.

13. A device for collecting data comprising a sensor positioned to gather measurement data from a sampling region or a sampling point, an illumination device integrated into the sensor device for illuminating the sampling region or the sampling point, an arm affixed to the sensor for mounting the sensor on a construction machine.

14. The sensor device of claim 13, wherein the sensor comprises an optical sensor.

15. The sensor device of claim 14, further comprising a camera positioned to capture an image of the area illuminated by the illumination device.

16. The sensor arrangement of claim 1, where the sensor is a non-optical sensor.

17. The device of claim 13, wherein the sensor is a non-optical sensor.
